(19) United States
(12) Patent Application Publication
(10) Pub. No.: US 2017/0193364 A1
(43) Pub. Date: Jul. 6, 2017

(54) LEARNING METHOD FOR SYNAPSES OF A NEUROMORPHIC DEVICE

(71) Applicant: SK hynix Inc., Icheon (KR)

(72) Inventor: Hyung-Dong LEE, Icheon (KR)

(21) Appl. No.: 15/386,996

(22) Filed: Dec. 21, 2016

Related U.S. Application Data
(60) Provisional application No. 62/273,269, filed on Dec. 30, 2015.

(30) Foreign Application Priority Data
Sep. 13, 2016 (KR) 10-2016-0117984

(51) Int. Cl. G06N 3/08; G06N 3/04

(52) U.S. Cl. CPC G06N 3/08; G06N 3/04

(57) ABSTRACT

A learning method for synapses of a neuromorphic device may include generating and inputting, by a pre-synaptic neuron, a first pre-synaptic pulse to a plurality of synapses at a first start time, the plurality of synapses being coupled to the pre-synaptic neuron; generating and inputting, by a first post-synaptic neuron, a first post-synaptic pulse to a first synapse of the plurality of synapses at a first delayed time that is delayed by a first delay amount from the first start time, the first synapse being coupled to the first post-synaptic neuron; and generating and inputting, by a second post-synaptic neuron, a second post-synaptic pulse to a second synapse of the plurality of synapses at a second delayed time that is delayed by a second delay amount from the first start time, the second synapse being coupled to the second post-synaptic neuron.

### CROSS-REFERENCE TO RELATED APPLICATIONS

The present application claims priority of U.S. Provisional Patent Application No. 62/273,269, filed on Dec. 30, 2015 and Korean Patent Application No. 10-2016-0117984, filed on Sep. 13, 2016, which is incorporated herein by reference in its entirety.

### BACKGROUND

1. Field

Exemplary embodiments of the present disclosure relate to a learning method for synapses of a neuromorphic device.

2. Description of the Related Art

Recently, much attention has been paid to neuromorphic technology using chips that mimics the human brain. A neuromorphic device used in the neuromorphic technology includes a plurality of pre-synaptic neurons, a plurality of post-synaptic neurons, and a plurality of synapses. The neuromorphic device outputs pulses or spikes depending on a variety of levels, amplitudes, or times, according to learning states. When synapses of the neuromorphic device are made to learn, the synapses of the neuromorphic device may have high resistance dispersion for their efficiency. When the synapses of the neuromorphic device have a variety of resistance levels, a specific synapse can be made to rapidly learn within a short time.

### SUMMARY

Various embodiments of the present disclosure are directed to a learning method for synapses of a neuromorphic device.

Also, various embodiments of the present disclosure are directed to a neuromorphic device which can be efficiently trained.

In an embodiment of the inventive concepts, a learning method for synapses of a neuromorphic device may include generating and inputting, by a pre-synaptic neuron, a first pre-synaptic pulse to a plurality of synapses at a first start time, the plurality of synapses being coupled to the pre-synaptic neuron; generating and inputting, by a first post-synaptic neuron, a first post-synaptic pulse to a first synapse of the plurality of synapses at a first delayed time that is delayed by a first delay amount from the first start time, the first synapse being coupled to the first post-synaptic neuron; and generating and inputting, by a second post-synaptic neuron, a second post-synaptic pulse to a second synapse of the plurality of synapses at a second delayed time that is delayed by a second delay amount from the first start time, the second synapse being coupled to the second post-synaptic neuron.

The learning method may further include generating and inputting, by a third post-synaptic neuron, a third post-synaptic pulse to a third synapse of the plurality of synapses at a third delayed time, the third synapse being coupled to the third post-synaptic neuron.

The learning method may further include generating and inputting, by a fourth post-synaptic neuron, a fourth post-synaptic pulse to a fourth synapse of the plurality of synapses at a fourth delayed time, the fourth synapse being coupled to the fourth post-synaptic neuron.

The learning method may further include: generating and inputting, by the pre-synaptic neuron, a second pre-synaptic pulse to the plurality of synapses at a second start time; generating and inputting, by the second post-synaptic neuron, the first post-synaptic pulse to the second synapse at a first delayed time that is delayed by the first delay amount from the second start time; and generating and inputting, the first post-synaptic neuron, the second post-synaptic pulse to the first synapse at a second delayed time that is delayed by the second delay amount from the second start time.

The first synapse may be is disposed at an intersection between a row line and a first column line, and the second synapse may be is disposed at an intersection between the row line and a second column line, the row line extending from the pre-synaptic neuron, the first and second column lines extending from the first and second post-synaptic neurons, respectively.

The first and second delay amounts may be adjusted by a timing controller electrically connected to the first and second post-synaptic neurons.

The first pre-synaptic pulse may overlap the first post-synaptic pulse by a first duty time, and the first pre-synaptic pulse may overlap the second post-synaptic pulse by a second duty time.

The first duty time may be longer than the second duty time.

The first pre-synaptic pulse may have a first polarity, and the first and second post-synaptic pulses may have a second polarity.

The first pre-synaptic pulse may have a first polarity, and the first and second post-synaptic pulses may have a second polarity.

In an embodiment of the inventive concepts, a learning method for synapses of a neuromorphic device may include generating and inputting, by a pre-synaptic neuron, a first pre-synaptic pulse to first to fourth synapses at a first start time, during a first cycle, the first to fourth synapses being electrically connected to the pre-synaptic neuron; generating and inputting, by a first post-synaptic neuron, a first post-synaptic pulse to the first synapse at a first delayed time that is delayed from the first start time; generating and inputting, by a second post-synaptic neuron, a second post-synaptic pulse to the second synapse at a second delayed time that is delayed from the first delayed time; generating and inputting, by a third post-synaptic neuron, a third post-synaptic pulse to the third synapse at a third delayed time that is delayed from the second delayed time; and generating and inputting, by a fourth post-synaptic neuron, a fourth post-synaptic pulse to the fourth synapse at a fourth delayed time that is delayed from the third delayed time.

The learning method may further include: generating and inputting, by the pre-synaptic neuron, a second pre-synaptic pulse to the first to fourth synapses at a second start time, during a second cycle; generating and inputting, by the second post-synaptic neuron, a fifth post-synaptic pulse to the second synapse at a fifth delayed time that is delayed from the second start time; generating and inputting, by the third post-synaptic neuron, a sixth post-synaptic pulse to the third synapse at a sixth delayed time that is delayed from the fifth delayed time; generating and inputting, by the fourth post-synaptic neuron, a seventh post-synaptic pulse to the fourth synapse at a seventh delayed time that is delayed from the sixth delayed time; and generating and inputting, by the first post-synaptic neuron, an eighth post-synaptic pulse to the first synapse at an eighth delayed time that is delayed from the seventh delayed time.

The learning method may further include: generating and inputting, by the pre-synaptic neuron, a third pre-synaptic pulse to the first and fourth synapses at a third start time during a third cycle; generating and inputting, by the third post-synaptic neuron, a ninth post-synaptic pulse to the third synapse at a ninth delayed time that is delayed from the third start time; generating and inputting, by the fourth post-synaptic neuron, a tenth post-synaptic pulse to the fourth synapse at a tenth delayed time that is delayed from the ninth delayed time; generating and inputting, by the first post-synaptic neuron, an eleventh post-synaptic pulse to the first synapse at an eleventh delayed time that is delayed from the tenth delayed time; and generating and inputting, by the second post-synaptic neuron, a twelfth post-synaptic pulse to the second synapse at a twelfth delayed time that is delayed from the eleventh delayed time.

The learning method may further include: generating and inputting, by the pre-synaptic neuron, a fourth pre-synaptic pulse to the first to fourth synapses at a fourth start time during a fourth cycle; generating and inputting, by the fourth post-synaptic neuron, a thirteenth post-synaptic pulse to the fourth synapse at a thirteenth delayed time that is delayed from the fourth start time; generating and inputting, by the first post-synaptic neuron, a fourteenth post-synaptic pulse to the first synapse at a fourteenth delayed time that is delayed from the thirteenth delayed time; generating and inputting, by the second post-synaptic neuron, a fifteenth post-synaptic pulse to the second synapse at a fifteenth delayed time that is delayed from the fourteenth delayed time; and generating and inputting, by the third post-synaptic neuron, a sixteenth post-synaptic pulse to the third synapse at a sixteenth delayed time that is delayed from the fifteenth delayed time.

The first to fourth delayed times may be adjusted by a timing controller which is electrically connected to the first to fourth post-synaptic neurons.

In an embodiment of the inventive concepts, a learning method for synapses of a neuromorphic device may include generating and inputting, by a first pre-synaptic neuron, a first pre-synaptic pulse to a plurality of synapses at a start time, the plurality of synapses being electrically connected to the first pre-synaptic neuron; generating and inputting, by a first post-synaptic neuron bundle having a plurality of first post-synaptic neurons, a plurality of first post-synaptic pulses to first synapses among the plurality of synapses at a first delayed time, the first synapses being electrically connected to the first post-synaptic neuron bundle; and generating and inputting, by a second post-synaptic neuron bundle having a plurality of second post-synaptic neurons, a plurality of second post-synaptic pulses to second synapses among the plurality of synapses at a second delayed time, the second synapses being electrically connected to the second post-synaptic neuron bundle.

The learning method may further include generating and inputting, by a third post-synaptic neuron bundle having a plurality of third post-synaptic neurons, a plurality of third post-synaptic pulses to third synapses among the plurality of synapses at a third delayed time, the third synapses being electrically connected to the third post-synaptic neuron bundle.

The learning method may further include generating and inputting, by a fourth post-synaptic neuron bundle having a plurality of fourth post-synaptic neurons, a plurality of fourth post-synaptic pulses to fourth synapses among the plurality of synapses at a fourth delayed time, the fourth synapses being electrically connected to the fourth post-synaptic neuron bundle.

The first delayed time may be delayed by a first delay amount from the start time, the second delayed time may be delayed by a second delay amount from the first delayed time, the third delayed time may be delayed by a third delay amount from the second delayed time, and the fourth delayed time may be delayed by a fourth delay amount from the third delayed time.

The first to fourth delay amounts may have the same length.

### BRIEF DESCRIPTION OF THE DRAWINGS

FIG. 1 is a block diagram conceptually illustrating a neuromorphic device in accordance with an embodiment of the present disclosure.

FIGS. 2A to 2D are timing diagrams for describing a learning method for synapses of a neuromorphic device in accordance with an embodiment of the present disclosure.

FIG. 3 is a graph illustrating changes in resistance values of the synapses of the neuromorphic device after the synapses are trained through the learning method in accordance with the embodiment of the present disclosure.

FIG. 4 is a graph conceptually illustrating resistance values of the synapses changing according to initial resistance distribution of the synapses, after the synapses of the neuromorphic device are trained through the learning method in accordance with the embodiment of the present disclosure.

FIGS. 5A and 5B are a block diagram and a timing diagram, respectively, for describing a learning method of synapses of a neuromorphic device in accordance with an embodiment of the present disclosure.

FIG. 6 is a timing diagram for describing the learning method for the synapses of the neuromorphic device in accordance with the embodiment of the present disclosure.

FIG. 7 is a block diagram conceptually illustrating a neuromorphic device in accordance with another embodiment of the present disclosure.

FIGS. 8A to 8C are block diagrams conceptually illustrating neuromorphic devices in accordance with other embodiments of the present disclosure.

FIG. 9 is a block diagram conceptually illustrating a pattern recognition system in accordance with an embodiment of the present disclosure.

### DETAILED DESCRIPTION

Specific structural or functional descriptions for various embodiments disclosed in this specification are only used for describing the various embodiments, and the embodiments can be modified in various manners, and are not limited thereto.

The embodiments of the inventive concepts may include various modifications and shapes, and thus will be illustrated in the drawings and described in detail in this specification. However, the embodiments are not limited to specific embodiments, and may include all of variations, equivalents, and substitutes without departing from the scope of the inventive concepts.

Although the terms first and second can be used to describe various elements, the elements should not be limited by the terms. The terms are only used to distinguish one element from another element. For example, a first component may be referred to as a second component, and the second component may be referred to as the first embodiment, without departing from the scope of the inventive concepts.

When an element is referred to as being “connected” or “coupled” to another element, it should be understood that the former element can be directly connected or coupled to the latter element, or connected or coupled to the latter element with another element interposed therebetween. On the other hand, when an element is referred to as being “directly connected” or “directly coupled” to another element, it may be understood that no element is interposed therebetween. Other expressions for describing the relation between elements, that is, “between” and “immediately between” or “adjacent to” and “directly adjacent to” may be understood in the same manner.

The terms used in this specification are used only to describe specific embodiments, and not intended to limit the inventive concepts. The terms of a singular form may include plural forms unless referred to the contrary. In this application, the term such as “include” or “have” specifies a feature, number, step, operation, element, part or combination thereof which is described in the specification, but does not exclude one or more other features, numbers, steps, operations, elements, parts or combinations thereof.

All terms used herein, including technical or scientific terms, have the same meanings as the terms which are generally understood by those skilled in the art to which the inventive concepts pertains, as long as they are differently defined. The terms defined in a generally used dictionary should be analyzed to have meanings which coincide with contextual meanings in the related art. As long as the terms are not clearly defined in this specification, the terms are not analyzed as ideal or excessively formal meanings.

Throughout the specification, like reference numerals refer to like elements. Therefore, although the same or similar reference numerals are not mentioned or described in a corresponding drawing, the reference numerals can be described with reference to other drawings. Furthermore, although elements are not represented by reference numerals, the elements can be described with reference to other drawings.

In this specification, ‘potentiation’, ‘set’, ‘training’, and ‘learning’ may be used as the same or similar terms, and ‘depressing’, ‘reset’, and ‘initiation’ may be used as the same or similar terms. For example, an operation of lowering resistance values of synapses may be exemplified as potentiation, setting, training, or learning, and an operation of raising the resistance values of synapses may be exemplified as depressing, resetting, or initiation. Furthermore, when a synapse is potentiated, set, trained, or learned, a gradually increasing voltage/current may be outputted from the synapse because the conductivity of the synapse is increased. When a synapse is depressed, reset, or initiated, a gradually decreasing voltage/current may be outputted from the synapse because the conductivity of the synapse is decreased. For convenience of description, a data pattern, an electrical signal, a pulse, a spike, and a fire may each be interpreted as having the same, similar, or compatible meaning. Furthermore, a voltage and a current may be interpreted as having the same or compatible meaning.

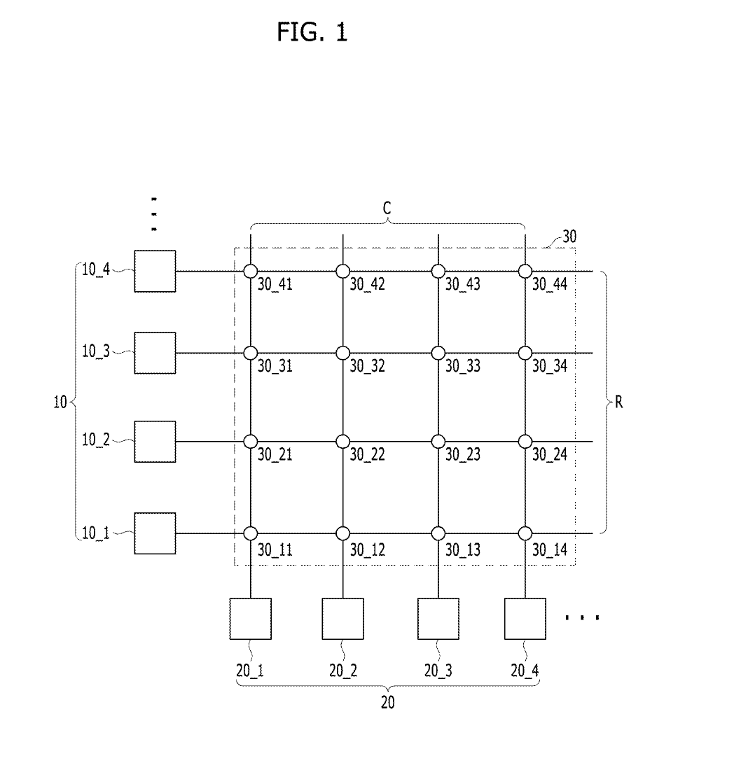

FIG. 1 is a block diagram conceptually illustrating a neuromorphic device in accordance with an embodiment of the present disclosure. Referring to FIG. 1, the neuromorphic device in accordance with the embodiment may include a plurality of pre-synaptic neurons 10, a plurality of post-synaptic neurons 20, and a plurality of synapses 30. The synapses 30 may be arranged at the respective intersections between row lines R extending from the pre-synaptic neurons 10 in a row direction and column lines C extending from the post-synaptic neurons 20 in a column direction. For illustrative convenience, FIG. 1 illustrates four pre-synaptic neurons 10_1 to 10_4, four post-synaptic neurons 20_1 to 20_4, and 16 synapses 30_11 to 30_14, 30_21 to 30_24, 30_31 to 30_34, and 30_41 to 30_44.

The pre-synaptic neurons 10 may transmit electrical pulses to the synapses 30 through the row lines R during a learning mode or a reading mode.

The post-synaptic neurons 20 may transmit electrical pulses to the synapses 30 through the column lines C during the learning mode, and receive electrical pulses from the synapses 30 through the column lines C during the reading mode.

The synapses 30 may include variable resistive devices. For example, the variable resistive devices of the synapses 30 may have a plurality of resistance levels. The variable resistive devices of the synapses 30 may include one or more of a metal oxide such as a transition metal oxide or a perovskite-based material, a phase-change material such as a chalcogenide-based material, a ferroelectric material, and a ferromagnetic material. The synapses 30 may be gradually changed between a high-resistance state and a low-resistance state according to the numbers of pulses, input time differences between the pulses, and/or voltage differences between the pulses. The pluses are inputted from the pre-synaptic neurons 10 and the post-synaptic neurons 20.

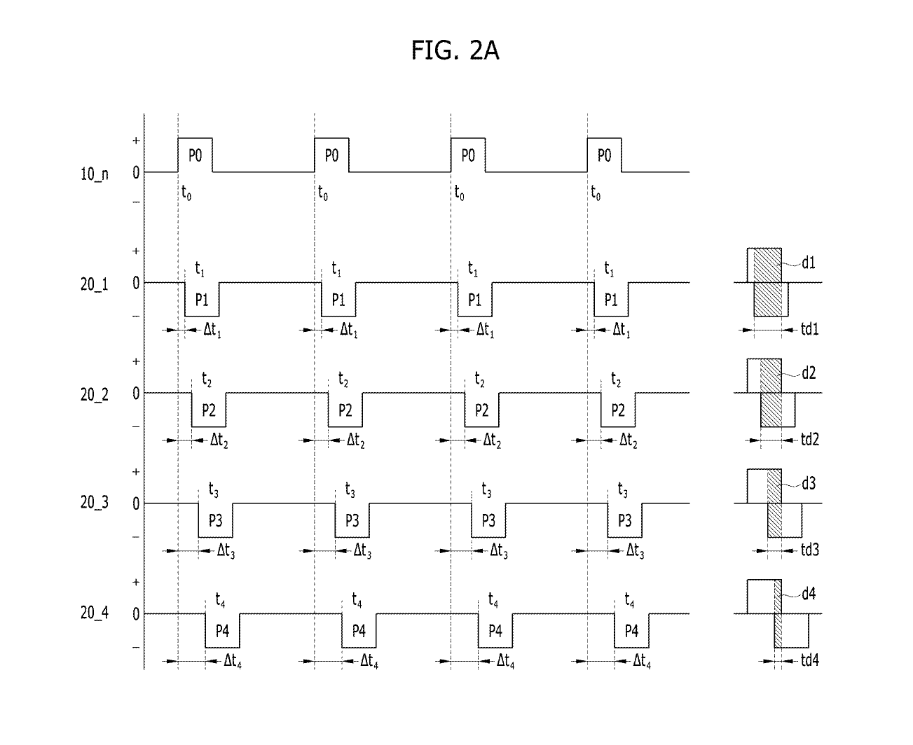

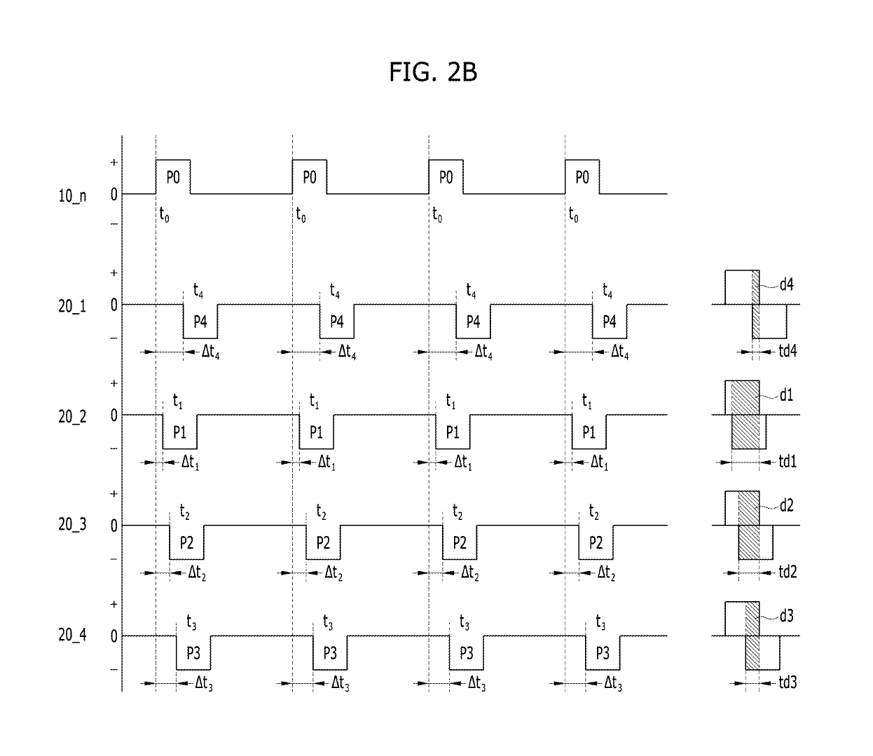

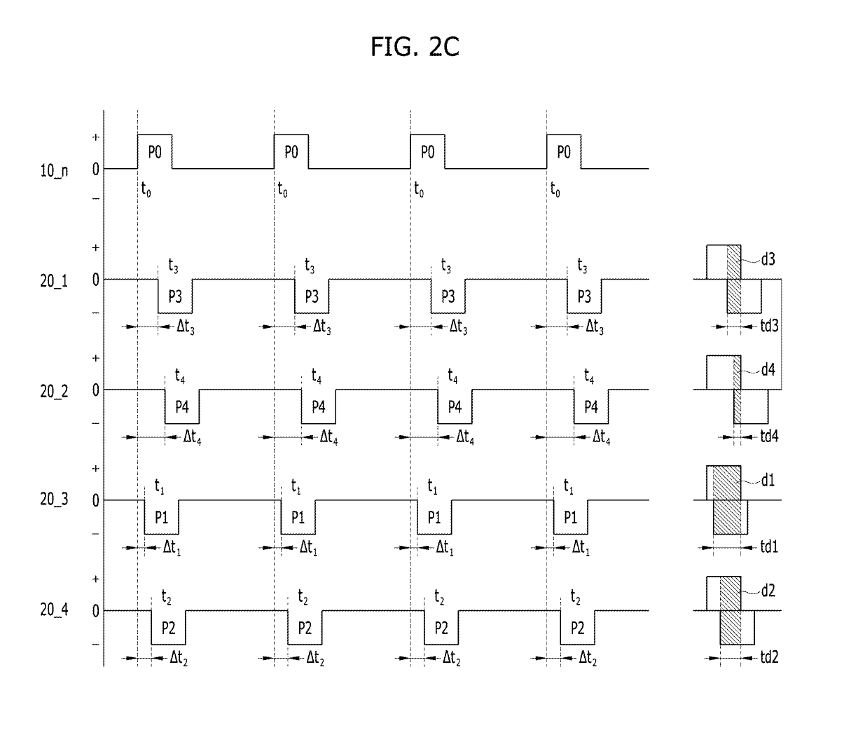

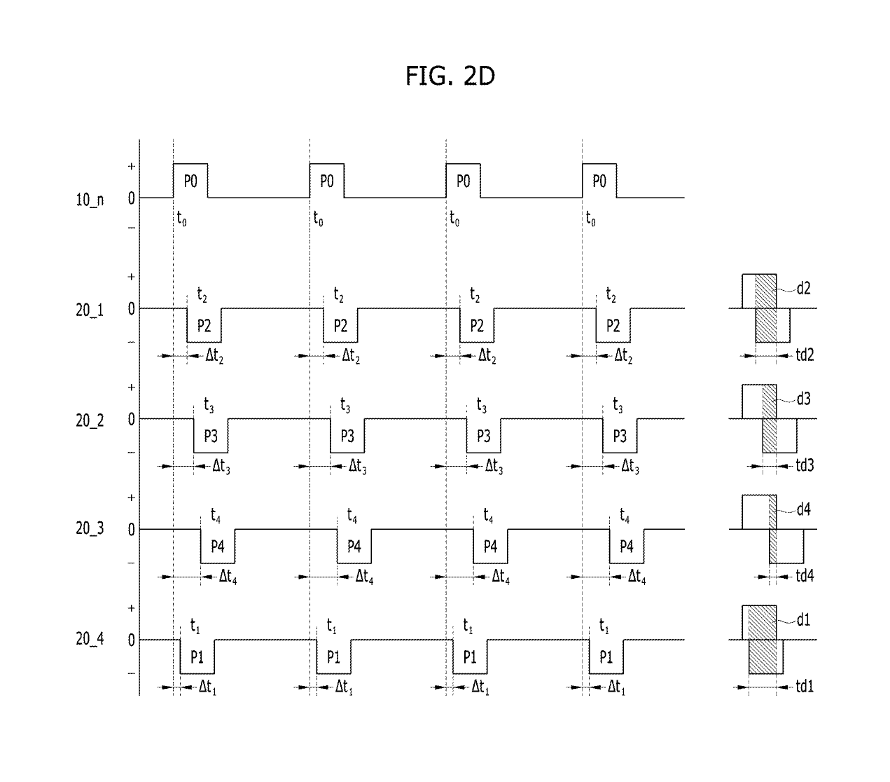

FIGS. 2A to 2D are timing diagrams for describing a learning method for the synapses 30 of the neuromorphic device in accordance with the embodiment of the present disclosure. Specifically, FIGS. 2A to 2D illustrate an electrical pulse P0 inputted from one arbitrary pre-synaptic neuron 10_n of the pre-synaptic neurons 10, as well as electrical pulses P1 to P4 inputted from four arbitrary post-synaptic neurons 20_1 to 20_4 of the post-synaptic neurons 20, respectively, n being a positive integer. In order to promote understanding of the inventive concepts, four synapses 30_n1 to 30_n4 connected to one row line R and four column lines C will be exemplarily described.

In the embodiment, suppose that the pre-synaptic neurons 10 generate a positive (+) pulse P0 and the post-synaptic neurons 20 generate negative (−) pulses P1 to P4. In another embodiment, however, the pre-synaptic neurons 10 may generate a negative pulse, and the post-synaptic neurons 20 may generate positive pulses. That is, pulses inputted to first electrodes of the synapses 30 may have a polarity opposite to a polarity of pulses inputted to second electrodes of the synapses 30. Thus, resistance values of the synapses 30 may be decreased or increased depending on the pulses inputted to the first and second electrodes of the synapses 30.

In other embodiments, both the pre-synaptic neurons 10 and the post-synaptic neurons 20 may generate positive pulses or generate negative pulses. That is, pulses having the same polarity may be inputted to the first and second electrodes of the synapses 30.

In an embodiment, the pre-synaptic neurons 10 and the post-synaptic neurons 20 may be compatible with each other. Specifically, the pre-synaptic neurons 10 may function as post-synaptic neurons, and the post-synaptic neurons 20 may function as pre-synaptic neurons.

Referring to FIG. 2A, during a first learning period, the pre-synaptic neuron 10_n may generate a pre-synaptic pulse P0 and input the pre-synaptic pulse P0 to the first electrodes of the synapses 30_n1 to 30_n4 at a start time t0, and the post-synaptic neurons 20_1 to 20_4 may generate post-synaptic pulses P1 to P4 and input the post-synaptic pulses P1 to P4 to the second electrodes of the synapses 30_n1 to 30_n4 at delayed times t1 to t4, respectively. The delayed times t1 to t4 have gradually increasing delay amounts from the start time t0. The first electrodes of the synapses 30_n1 to 30_n4 may be electrically connected to the row line R connected to the pre-synaptic neuron 10_n, and the second electrodes of the synapses 30_n1 to 30_n4 may be electrically connected to the column lines C connected to the post-synaptic neurons 20_1 to 20_4, respectively.

Specifically, the first post-synaptic neuron 20_1 may generate the first post-synaptic pulse P1 and input the first post-synaptic pulse P1 to the second electrode of the first synapse 30_n1 at the delayed time t1 delayed by a first delay amount Δt1 from the start time t0. The second post-synaptic neuron 20_2 may generate the second post-synaptic pulse P2 and input the second post-synaptic pulse P2 to the second electrode of the second synapse 30_n2 at the time t2 delayed by a second delay amount Δt2 from the start time t0. The third post-synaptic neuron 20_3 may generate the third post-synaptic pulse P3 and input the third post-synaptic pulse P3 to the second electrode of the third synapse 30_n3 at the time t3 delayed by a third delay amount Δt3 from the start time t0. The fourth post-synaptic neuron 20_4 may generate the fourth post-synaptic pulse P4 and input the fourth post-synaptic pulse P4 to the second electrode of the fourth synapse 30_n4 at the time t4 delayed by a fourth delay amount Δt4 from the start time t0. The first delay amount Δt1 may have the smallest length, and the fourth delay amount Δt4 may have the largest length (Δt1<Δt2<Δt3<Δt4). Thus, the first post-synaptic pulse P1 may be input to the synapse 30_n1 at first, and the fourth post-synaptic pulse P4 may be input to the synapse 30_n4 at last (P1→P2→P3→P4). The delay amounts Δt1, Δt2, Δt3, and Δt4 may be separated by the same time difference (for example, Δt1=Δt2−Δt1=Δt3−Δt2=Δt4−Δt3).

States in which the pre-synaptic pulse P0 overlaps the first to fourth post-synaptic pulses P1 to P4 are illustrated on the right side of FIG. 2A. Specifically, an overlap area between the pre-synaptic pulse P0 and the first post-synaptic pulse P1, that is, a first duty d1, may have the largest area, an overlap area between the pre-synaptic pulse P0 and the fourth post-synaptic pulse P4, that is, a fourth duty d4, may have the smallest area. An overlap area between the pre-synaptic pulse P0 and the second post-synaptic pulse P2, that is, a second duty d2, and an overlap area between the pre-synaptic pulse P0 and the third post-synaptic pulse P3, that is, a third duty d3, may be between the first duty d1 and the fourth duty d4. That is, d1>d2>d3>d4.

The synapse 30_n1 connected to the first post-synaptic neuron 20_1 may be trained during a first duty time td1, the synapse 30_n2 connected to the second post-synaptic neuron 20_2 may be trained during a second duty time td2, the synapse 30_n3 connected to the third post-synaptic neuron 20_3 may be trained during a third duty time td3, and the synapse 30_n4 connected to the fourth post-synaptic neuron 20_4 may be trained during a fourth duty time td4. Since the first duty time td1 has the largest length and the fourth duty time td4 has the smallest length, the synapse 30_n1 connected to the first post-synaptic neuron 20_1 may be trained during the longest duty time, and the synapse 30_n4 connected to the fourth post-synaptic neuron 20_4 may be trained during the shortest duty time.

During the training time, i.e. duties times, the resistance values of the synapses 30 may be changed. Since the duty times td1 to td4 for which the pre-synaptic pulse 10 overlaps the post-synaptic pulses P1 to P4 are decreased from the first duty time td1 to the fourth duty time td4 (td1>td2>td3>td4) during the first learning period shown in FIG. 2A, the synapses 30_11, 30_21, 30_31, 30_41, . . . , 30_n1 connected to the first post-synaptic neuron 20_1 may have the largest resistance change rate σ1, the synapses 30_14, 30_24, 30_34, 30_44, . . . , 30_n4 connected to the fourth post-synaptic neuron 20_4 may have the smallest resistance change rate σ4. The synapses 30_12, 30_22, 30_32, 30_42, . . . , 30_n2 connected to the second post-synaptic neuron 20_2 and the synapses 30_13, 30_23, 30_33, 30_43, . . . , 30_n3 connected to the third post-synaptic neuron 20_3 may have resistance change rates σ2 and σ3, respectively, between the resistance change rates σ1 and σ4. That is, σ1>σ2>σ3>σ4, wherein σ: resistance change rate.

Referring to FIG. 2B, during a second learning period, the pre-synaptic neuron 10_n may generate and input a pre-synaptic pulse P0 to the first electrodes of the synapses 30_n1 to 30_n4 at a predetermined start time t0, and the post-synaptic neurons 20_1 to 20_4 may generate post-synaptic pulses P4, P1, P2, and P3 and input the generated pulses P4, P1, P2, and P3 to the second electrodes of the synapse 30_n1 to 30_n4 at the delayed times t4, t1, t2, and t3, respectively.

Specifically, the second post-synaptic neuron 20_2 may generate and input the first post-synaptic pulse P1 to the second electrode of the second synapse 30_n2 at the delayed time t1 delayed by the first delay amount Δt1 from the start time t0, the third post-synaptic neuron 20_3 may generate and input the second post-synaptic pulse P2 to the second electrode of the third synapse 30_n3 at the time t2 delayed by the second delay amount Δt2 from the start time t0, the fourth post-synaptic neuron 20_4 may generate and input the third post-synaptic pulse P3 to the second electrode of the fourth synapse 30_n4 at the time t3 delayed by the third delay amount Δt3 from the start time t0, and the first post-synaptic neuron 20_1 may generate and input the fourth post-synaptic pulse P4 to the second electrode of the first synapse 30_n1 at the time t4 delayed by the fourth delay amount Δt4 from the start time t0. In FIG. 2B, the first to fourth delay amounts Δt1 to Δt4 may have the same values as illustrated in FIG. 2A (i.e., Δt1<Δt2<Δt3<Δt4).

States in which the pre-synaptic pulse P0 overlaps the first to fourth post-synaptic pulses P1 to P4 are illustrated on the right side of FIG. 2B. The synapse 30_n2 connected to the second post-synaptic neuron 20_2 may be trained during the first duty time td1, the synapse 30_n3 connected to the third post-synaptic neuron 20_3 may be trained during the second duty time td2, the synapse 30_n4 connected to the fourth post-synaptic neuron 20_4 may be trained during the third duty time td3, and the synapse 30_n1 connected to the first post-synaptic neuron 20_1 may be trained during the fourth duty time td4. The first to fourth duties d1 to d4 may be proportional to the first to fourth duty times td1 to td4, respectively, and amplitude differences between the pre-synaptic pulse P0 and the first to fourth post-synaptic pulses P1 to P4, respectively. Therefore, when the first to fourth post-synaptic pulses P1 to P4 have the same amplitude, the first to fourth duties d1 to d4 may be proportional to only the first to fourth duty times td1 to td4, respectively.

Since the first duty time td1 has the largest length and the fourth duty time td4 has the smallest length, the synapse 30_n2 connected to the second post-synaptic neuron 20_2 may be trained during the longest time, and the synapse 30_n1 connected to the first post-synaptic neuron 20_1 may be trained during the shortest time. Thus, during the second learning period, the synapses 30_12, 30_22, 30_32, 30_42, . . . , 30_n2 connected to the second post-synaptic neuron 20_2 may have the largest resistance change rate σ2, the synapses 30_14, 30_24, 30_34, 30_44, . . . , 30_n4 connected to the first post-synaptic neuron 20_1 may have the smallest resistance change rates σ1. The synapses 30_13, 30_23, 30_33, 30_43, . . . , 30_n3 connected to the third post-synaptic neuron 20_3 and the synapses 30_14, 30_24, 30_34, 30_44, . . . , 30_n4 connected to the fourth post-synaptic neuron 20_4 may have resistance change rates σ3 and σ4, respectively, between the resistance change rates σ2 and σ1. That is, σ2>σ3>σ4>σ1.

Referring to FIG. 2C, during a third learning period, the pre-synaptic neuron 10_n may generate and input a pre-synaptic pulse P0 to the first electrodes of the synapses 30_n1 to 30_n4 at a predetermined start time t0, and the post-synaptic neurons 20_1 to 20_4 may generate post-synaptic pulses P3, P4, P1, and P2 and input the generated pulses P3, P4, P1, and P2 to the second electrodes of the synapse 30_n1 to 30_n4 at delayed times t3, t4, t1, and t2, respectively.

Specifically, the third post-synaptic neuron 20_3 may generate and input the first post-synaptic pulse P1 to the second electrode of the third synapse 30_n3 at the delayed time t1 delayed by the first delay amount Δt1 from the start time t0, the fourth post-synaptic neuron 20_4 may generate and input the second post-synaptic pulse P2 to the second electrode of the fourth synapse 30_n4 at the time t2 delayed by the second delay amount Δt2 from the start time t0, the first post-synaptic neuron 20_1 may generate and input the third post-synaptic pulse P3 to the second electrode of the first synapse 30_n1 at the time t3 delayed by the third delay amount Δt3 from the start time t0, and the second post-synaptic neuron 20_2 may generate and input the fourth post-synaptic pulse P4 to the second electrode of the second synapse 30_n2 at the time t4 delayed by the fourth delay amount Δt4 from the start time t0. In FIG. 2C, the first to fourth delay amounts Δt1 to Δt4 may have the same values as illustrated in FIG. 2A or 2B (i.e., Δt1<Δt2<Δt3<Δt4).

States in which the pre-synaptic pulse P0 overlaps the first to fourth post-synaptic pulses P1 to P4 are illustrated on the right side of FIG. 2C. The synapse 30_n3 connected to the third post-synaptic neuron 20_3 may be trained during the first duty time td1, the synapse 30_n4 connected to the fourth post-synaptic neuron 20_4 may be trained during the second duty time td2, the synapse 30_n1 connected to the first post-synaptic neuron 20_1 may be trained during the third duty time td3, and the synapse 30_n2 connected to the second post-synaptic neuron 20_2 may be trained during the fourth duty time td4.

Since the first duty time td1 has the largest length and the fourth duty time td4 has the smallest length, the synapse 30_n3 connected to the third post-synaptic neuron 20_3 may be trained for the longest time, and the synapse 30_n2 connected to the second post-synaptic neuron 20_2 may be trained during the shortest time. Thus, during the third learning period, the synapses 30_13, 30_23, 30_33, 30_43, . . . , 30_n3 connected to the third post-synaptic neuron 20_3 may have the largest resistance change rate σ3, the synapses 30_12, 30_22, 30_32, 30_42, . . . , 30_n2 connected to the second post-synaptic neuron 20_2 may have the smallest resistance change rate σ2. The synapses 30_14, 30_24, 30_34, 30_44, . . . , 30_n4 connected to the fourth post-synaptic neuron 20_4 and the synapses 30_11, 30_21, 30_31, 30_41, . . . , 30_n1 connected to the first post-synaptic neuron 20_1 may have resistance change rates σ4 and σ1, respectively, between the resistance change rates σ3 and σ2. That is, σ3>σ4>σ1>σ2.

Referring to FIG. 2D, during a fourth learning period, the pre-synaptic neuron 10_n may generate a pre-synaptic pulse P0 and input the generated pulse P0 to the first electrodes of the synapses 30_n1 to 30_n4 at a predetermined start time t0, and the post-synaptic neurons 20_1 to 20_4 may generate and input post-synaptic pulses P2, P3, P4, and P1 to the second electrodes of the synapses 30_n1 to 30_n4 at delayed times t2, t3, t4, and t1, respectively.

Specifically, the fourth post-synaptic neuron 20_4 may generate and input the first post-synaptic pulse P1 to the second electrode of the fourth synapse 30_n4 at the delayed time t1 delayed by the first delay amount Δt1 from the start time t0, the first post-synaptic neuron 20_1 may generate and input the second post-synaptic pulse P2 to the second electrode of the first synapse 30_n1 at the time t2 delayed by the second delay amount Δt2 from the time start t0, the second post-synaptic neuron 20_2 may generate and input the third post-synaptic pulse P3 to the second electrode of the second synapse 30_n2 at the time t3 delayed by the third delay amount Δt3 from the start time t0, and the third post-synaptic neuron 20_3 may generate and input the fourth post-synaptic pulse P4 to the second electrode of the third synapse 30_n3 at the time t4 delayed by the fourth delay amount Δt4 from the start time t0. In FIG. 2D, the first to fourth delay amounts Δt1 to Δt4 may have the same values as illustrated in FIG. 2A, 2B, or 2C (i.e., Δt1<Δt2<Δt3<Δt4).

States in which the pre-synaptic pulse P0 overlaps the first to fourth post-synaptic pulses P1 to P4 are illustrated on the right side of FIG. 2D. The synapse 30_n4 connected to the fourth post-synaptic neuron 20_4 may be trained for the first duty time td1, the synapse 30_n1 connected to the first post-synaptic neuron 20_1 may be trained for the second duty time td2, the synapse 30_n2 connected to the second post-synaptic neuron 20_2 may be trained for the third duty time td3, and the synapse 30_n3 connected to the third post-synaptic neuron 20_3 may be trained for the fourth duty time td4.

Since the first duty time td1 has the largest length and the fourth duty time td4 has the smallest length, the synapse 30_n4 connected to the fourth post-synaptic neuron 20_4 may be trained for the longest time, and the synapse 30_n3 connected to the third post-synaptic neuron 20_3 may be trained for the shortest time. Thus, during the fourth learning period, the synapses 30_14, 30_24, 30_34, 30_44, . . . , 30_n4 connected to the fourth post-synaptic neuron 20_4 may have the largest resistance change rate σ4, the synapses 30_13, 30_23, 30_33, 30_43, . . . , 30_n3 connected to the third post-synaptic neuron 20_3 may have the smallest resistance change rate σ3, and the synapses 30_11, 30_21, 30_31, 30_41, . . . , 30_n1 connected to the first post-synaptic neuron 20_1 and the synapses 30_12, 30_22, 30_32, 30_42, . . . , 30_n2 connected to the second post-synaptic neuron 20_2 may have resistance change rates σ1 and σ2, respectively, between the resistance change rates σ4 and σ3 (σ4>σ1>σ2>σ3).

Referring to FIGS. 2A to 2D, the learning method for the synapses 30 of the neuromorphic device in accordance with the embodiment may include a process in which the post-synaptic neurons 20_1, 20_2, 20_3, 20_4, . . . , 20_m generate post-synaptic pulses P1, P2, P3, P4, . . . , Pm at sequentially delayed times t1, t2, t3, t4, . . . , tm and input the generated pulses P1, P2, P3, P4, . . . , Pm to the corresponding synapses 30, respectively, m being a positive integer. The delayed times t1, t2, t3, t4, . . . , tm may occur sequentially according to a plurality of learning periods as illustrated in FIGS. 2A to 2D.

Table 1 shows that sequentially delayed times t1, t2, t3, and t4 at which the first to fourth post-synaptic neurons 20_1 to 20_4 generate and input post-synaptic pulses P1 to P4 to the synapses 30 are circulated during one cycle when four learning periods are set to one cycle.

TABLE 1

| | First post- | Second post- | Third post- | |
|---|---|---|---|---|
| | synaptic | synaptic | synaptic | Fourth post- |
| | pulse | pulse | pulse | synaptic pulse |
| First learning | t1 | t2 | t3 | t4 |
| period | | | | |
| Second | t4 | t1 | t2 | t3 |
| learning period | | | | |
| Third learning | t3 | t4 | t1 | t2 |
| period | | | | |
| Fourth | t2 | t3 | t4 | t1 |
| learning period | | | | |

In accordance with the embodiment of the present disclosure, the first to fourth learning periods may be circulated a plurality of times. Thus, the delayed times t1, t2, t3, and t4 may be circulated during a plurality of cycles.

Furthermore, the learning periods may be more finely divided. That is, during four or more learning periods, post-synaptic pulses P1, P2, P3, P4, . . . , Pm may be generated at a plurality of delayed times t1, t2, t3, t4, . . . , tm.

In accordance with the embodiment of the present disclosure, the sum of the delayed amounts of the post-synaptic pulses P1, P2, P3, P4, . . . , Pm generated from the respective post-synaptic neurons 20_1, 20_2, 20_3, 20_4, . . . , 20_m may be substantially the same in each period.

Table 2 shows that delayed times t1, t2, t3, and t4 occur randomly during one cycle when four learning periods are set to one cycle. For example, Table 2 shows that the delayed times are delayed in order of the second post-synaptic pulse P2, the fourth post-synaptic pulse P4, the first post-synaptic pulse P1, and the third post-synaptic pulse P3, during one cycle.

TABLE 2

| | First post- | Second post- | Third post- | |
|---|---|---|---|---|
| | synaptic | synaptic | synaptic | Fourth post- |
| | pulse | pulse | pulse | synaptic pulse |
| First learning | t4 | t1 | t2 | t3 |
| period | | | | |
| Second | t2 | t3 | t4 | t1 |
| learning period | | | | |
| Third learning | t1 | t2 | t3 | t4 |
| period | | | | |
| Fourth | t3 | t4 | t1 | t2 |
| learning period | | | | |

Table 3 shows that delayed times t1 to t6 occur randomly during one cycle when six learning periods are set to one cycle.

TABLE 3

| | | Second | Third | Fourth | | |
|---|---|---|---|---|---|---|
| | First post- | post- | post- | post- | Fifth post- | Sixth post- |
| | synaptic | synaptic | synaptic | synaptic | synaptic | synaptic |
| | pulse | pulse | pulse | pulse | pulse | pulse |
| First | t1 | t2 | t3 | t4 | t5 | t6 |
| learning | | | | | | |
| period | | | | | | |
| Second | t3 | t4 | t5 | t6 | t1 | t2 |
| learning | | | | | | |
| period | | | | | | |
| Third | t5 | t6 | t1 | t2 | t3 | t4 |
| learning | | | | | | |
| period | | | | | | |
| Fourth | t2 | t3 | t4 | t5 | t6 | t1 |
| learning | | | | | | |
| period | | | | | | |
| Fifth | t6 | t1 | t2 | t3 | t4 | t5 |
| learning | | | | | | |
| period | | | | | | |
| Sixth | t4 | t5 | t6 | t1 | t2 | t3 |
| learning | | | | | | |
| period | | | | | | |

The random delay and circulation mechanism may be changed and applied in various manners.

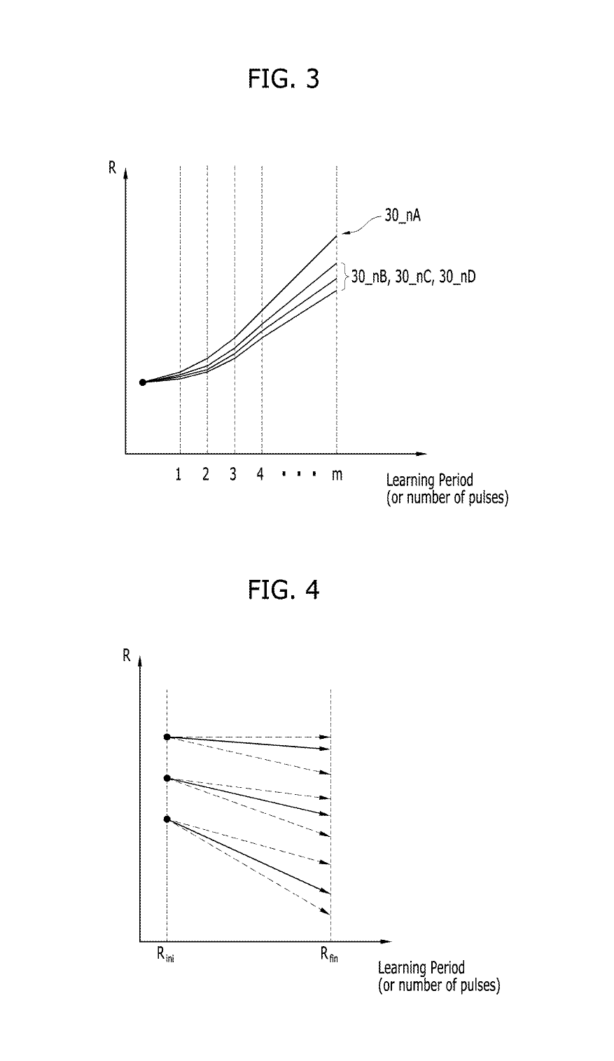

FIG. 3 is a graph illustrating changes in resistance of the synapses 30 of the neuromorphic device of FIG. 1 after the learning method is performed on the synapses 30 in accordance with the embodiment. FIG. 3 is based on the supposition that the resistance values are increased as the number of executed learning periods is increased. Referring to FIG. 3, synapses 30_nA, 30_nB, 30_nC, and 30_nD of the neuromorphic device, which are trained through the learning method in accordance with the embodiment, may have various resistance change rates GA, GB, GC, and GD, respectively. The dispersion of synaptic weights of the synapses 30_nA, 30_nB, 30_nC, and 30_nD can be increased as the number of executed learning periods is increased. Referring to FIG. 3, it is assumed that the synapse 30_nA is trained and the synapses 30_nB, 30_nC, and 30_nD are untrained. Thus, as the number of executed learning periods is increased, differences in resistance between the trained synapse 30_nA and the untrained synapses 30_nB, 30_nC, and 30_nD can be increased, and the learning and recognition efficiency for data patterns can be improved.

FIG. 4 is a graph conceptually illustrating that the resistance values of the synapses 30 are changed according to initial resistance distribution of the synapses 30, after the learning method is performed on the synapses 30 in accordance with the embodiment. FIG. 4 is based on the supposition that the resistance values are decreased as the number of executed learning periods is increased.

Referring to FIG. 4, the resistance values of the trained synapses 30 are changed according to the number of post-synaptic pulses inputted thereto at delayed times, and thus have various dispersions from the initial resistance distribution Rini to the final resistance distribution Rfin.

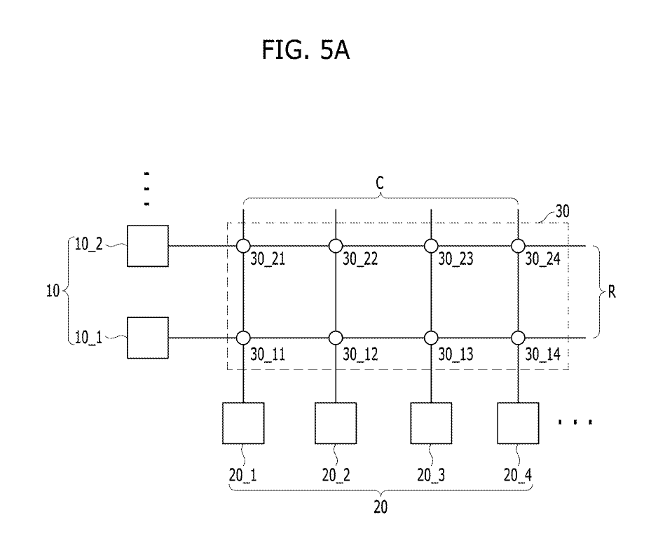

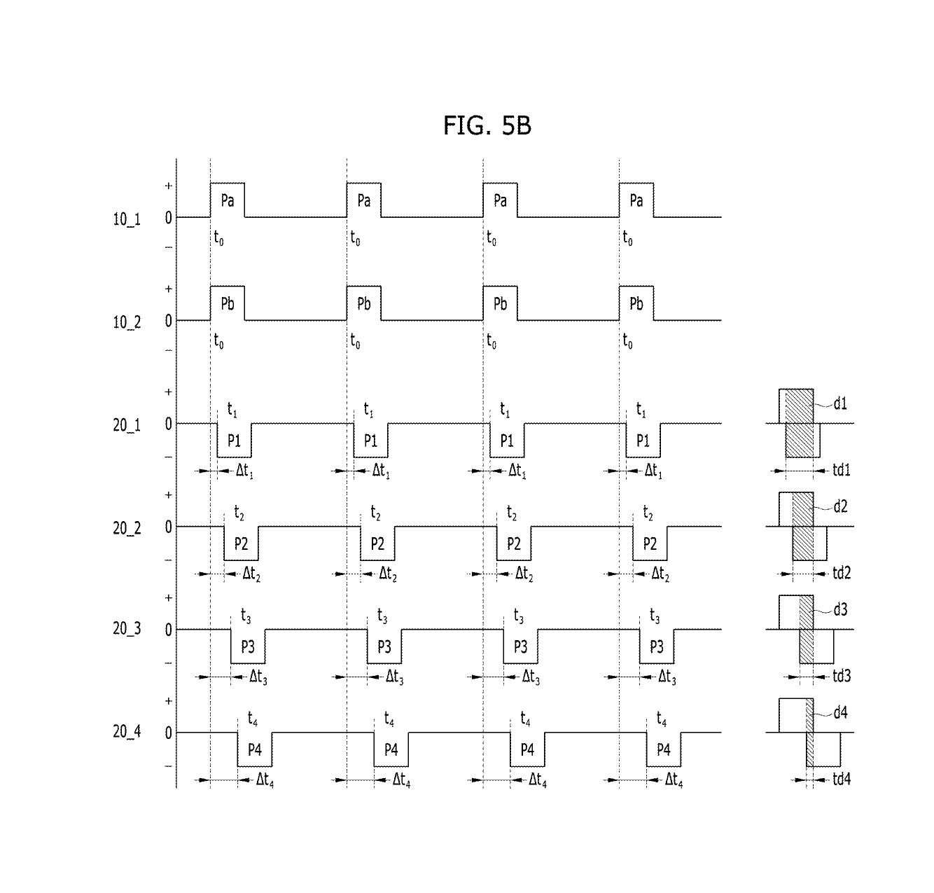

FIGS. 5A and 5B are a block diagram and a timing diagram for describing a learning method for the synapses 30 of a neuromorphic device in accordance with an embodiment, respectively. Specifically, FIGS. 5A and 5B illustrate electrical pulses Pa and Pb respectively inputted to the synapses 30_11 to 30_14 and 30_21 to 30_24 through row lines R from two arbitrary pre-synaptic neurons 10_1 and 10_2 among the pre-synaptic neurons 10. FIGS. 5A and 5B also illustrate electrical pulses P1 to P4 inputted to the synapses 30_11 to 30_41, 30_12 to 30_42, 30_13 to 30_43, and 30_14 to 30_44 from four arbitrary post-synaptic neurons 20_1, 20_2, 20_3, and 20_4, respectively, among the post-synaptic neurons 20.

Referring to FIGS. 5A and 5B, the pre-synaptic pulses Pa and Pb may be generated at the same start time t0 and inputted to the synapses 30, and the post-synaptic pulses P1 to P4 may be generated at different delayed times t1 to t4, respectively, and inputted to the synapses 30 during a learning period. For example, FIG. 5B illustrates one learning period of one cycle. Specifically, the post-synaptic neurons 20_1 to 20_4 generate post-synaptic pulses P1 to P4 at the circulated delayed times t1 to t4, respectively, for each of the four periods of one cycle. The synapses 30_11 to 30_14 connected to the first pre-synaptic neuron 10_1 and the synapses 30_21 to 30_24 connected to the second pre-synaptic neuron 10_2 may be independently trained by the first to fourth post-synaptic pulses P1 to P4.

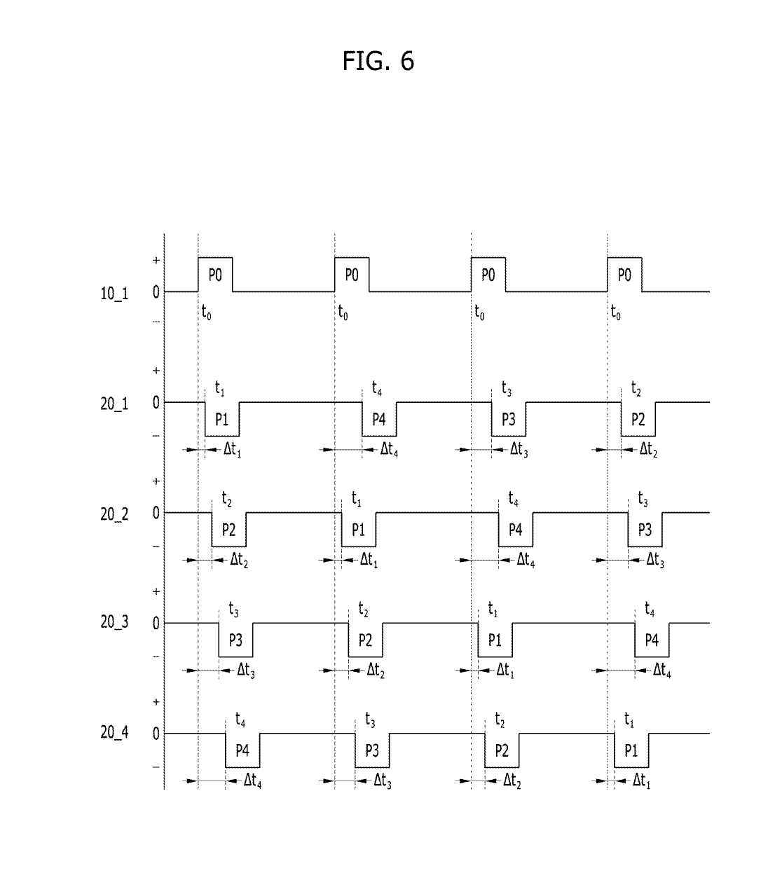

FIG. 6 is a timing diagram for describing the learning method for the synapses 30 of the neuromorphic device in accordance with another embodiment. Specifically, the post-synaptic pulses P1 to P4 may be generated at the delayed times t1 to t4, circulated within one cycle, and inputted to the synapses 30 in a circulated order.

For example, FIG. 6 illustrates one cycle including four periods having one pre-synaptic pulse P0 and one of the post-synaptic pulses P1 to P4. The post-synaptic neuron 20_1 sequentially generates post-synaptic pulses in an order of P1, P4, P3, and P2 in the four periods of one cycle. The post-synaptic pulse P1 is inputted to first synapses 30 connected to the post-synaptic neuron 20_1 at the delayed time t1 in the first learning period, the post-synaptic pulse P4 is inputted to the first synapses 30 at the delayed time t4 in the second learning period, the post-synaptic pulse P3 is inputted to the first synapses 30 at the delayed time t3 in the third learning period, and the post-synaptic pulse P2 is inputted to the first synapses 30 at the delayed time t2 in the fourth learning period.

The post-synaptic neuron 20_2 sequentially generates post-synaptic pulses in an order of P2, P1, P4, and P3 in the four periods of one cycle. The post-synaptic pulse P2 is inputted to second synapses 30 connected to the post-synaptic neuron 20_2 at the delayed time t2 in the first learning period, the post-synaptic pulse P1 is inputted to the second synapses 30 at the delayed time t1 in the second learning period, the post-synaptic pulse P4 is inputted to the second synapses 30 at the delayed time t4 in the third learning period, and the post-synaptic pulse P3 is inputted to the second synapses 30 at the delayed time t3 in the fourth learning period.

Similarly, the post-synaptic neuron 20_3 sequentially generates the post-synaptic pulses in an order of P3, P2, P1, and P4 in the four periods of one cycle and inputs the post-synaptic pulses P3, P2, P1, and P4 to third synapses 30 connected to the post-synaptic neuron 20_3 during the first to fourth learning periods, respectively, and the post-synaptic neuron 20_4 sequentially generates the post-synaptic pulses in an order of P4, P3, P2, and P1 in the four periods of one cycle and inputs the post-synaptic pulses P4, P3, P2, and P1 to fourth synapses 30 connected to the post-synaptic neuron 20_4 during the first to fourth learning periods, respectively.

In another embodiment, the delayed times t1 to t4 may randomly occur within one cycle, referring to Table 2 and the description thereof.

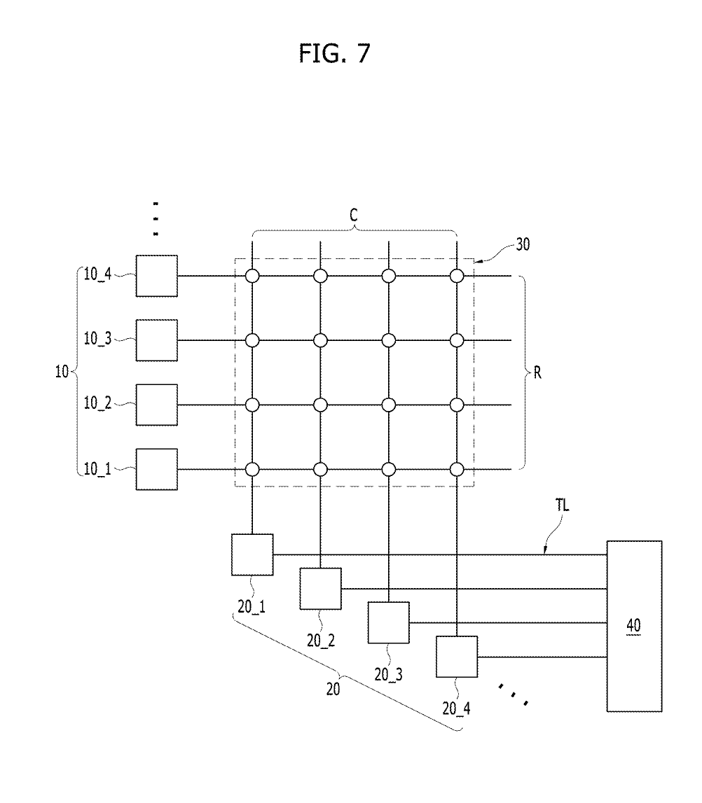

FIG. 7 is a block diagram conceptually illustrating a neuromorphic device in accordance with another embodiment. Referring to FIG. 7, the neuromorphic device may include a plurality of pre-synaptic neurons 10, a plurality of post-synaptic neurons 20, and a plurality of synapses 30, and may further include a timing controller 40. The timing controller 40 may be electrically connected to the post-synaptic neurons 20 through a plurality of timing lines TL. The pre-synaptic neurons 10, the post-synaptic neurons 20, and the synapses 30 may be substantially the same as those illustrated in FIG. 1. For the simplicity of explanation, the descriptions thereof will be omitted.

The timing controller 40 may differently control times at which the post-synaptic neurons 20 generate post-synaptic pulses and provide the generated post-synaptic pulses to the synapses 30. For example, the timing controller 40 may control the times at which the post-synaptic pulses are generated, such that the first to fourth post-synaptic neurons 20_1 to 20_4 generate sequentially delayed first to fourth post-synaptic pulses at predetermined times. In other embodiments, the timing controller 40 may control the times at which the first to fourth post-synaptic pulses are generated, such that the first to fourth post-synaptic pulses are randomly delayed. The timing controller 40 may control first to fourth delay amounts of the first to fourth post-synaptic pulses using an on/off switching element or time delay circuit.

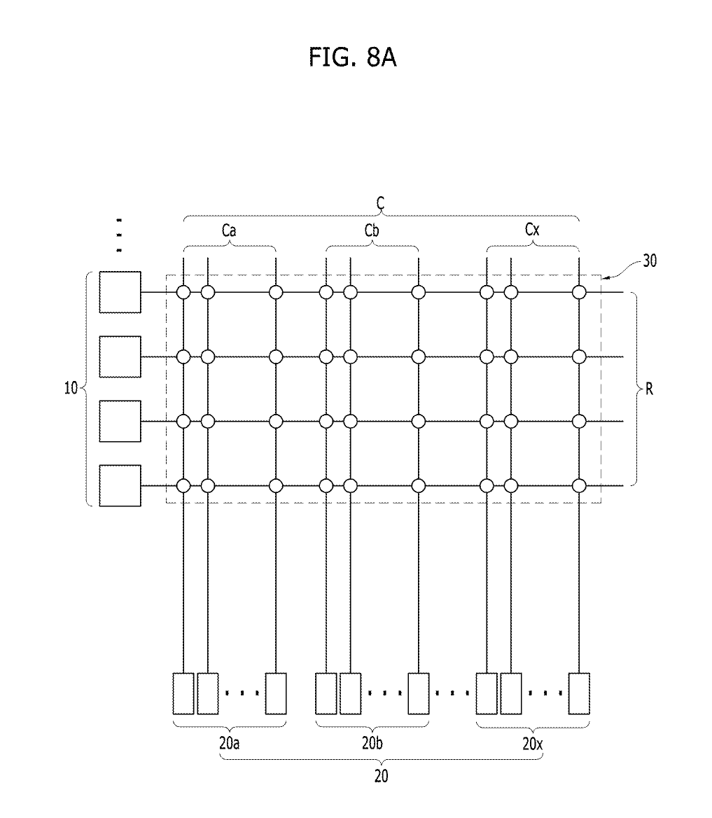

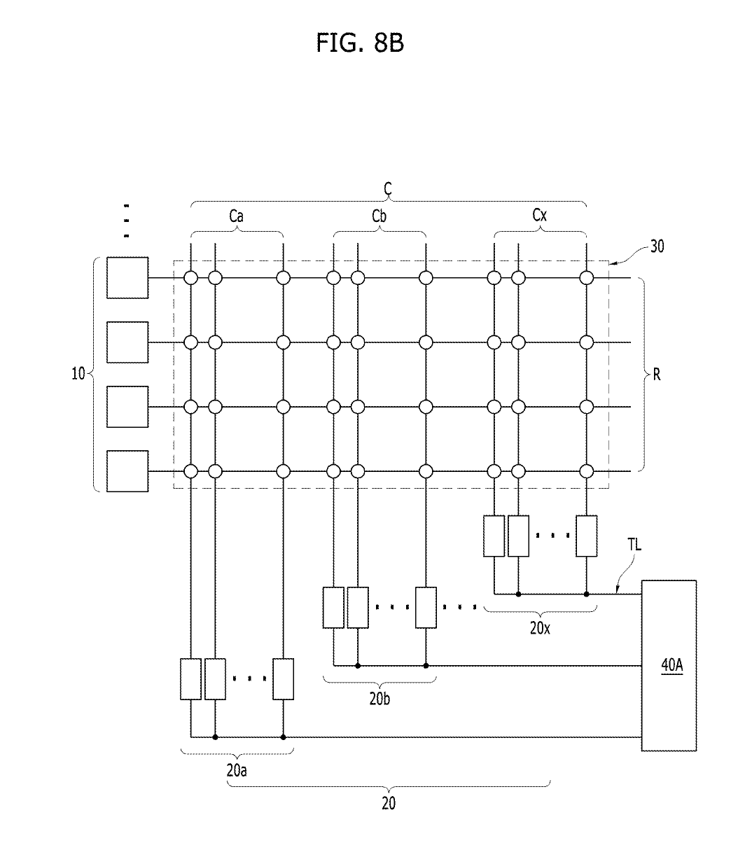

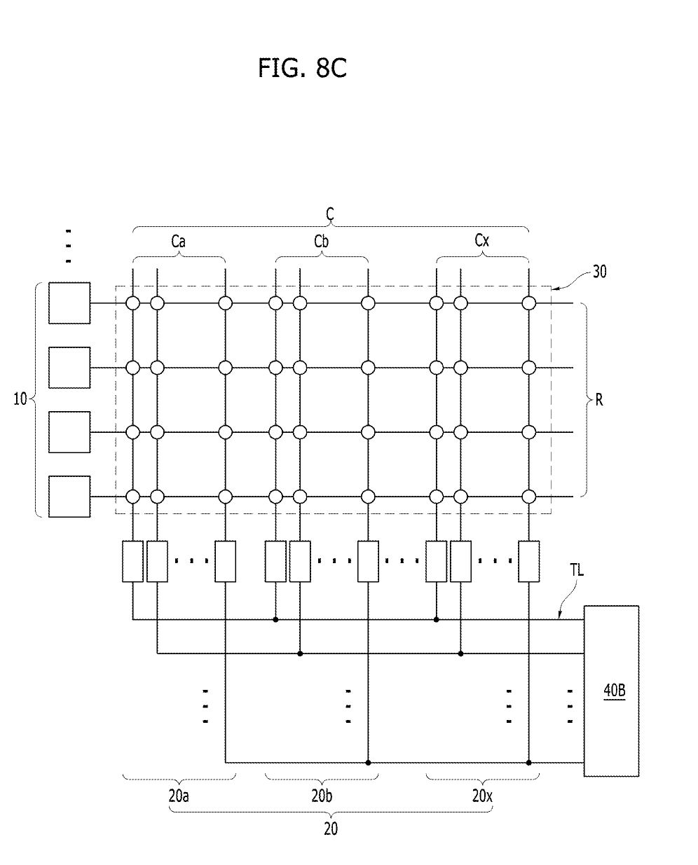

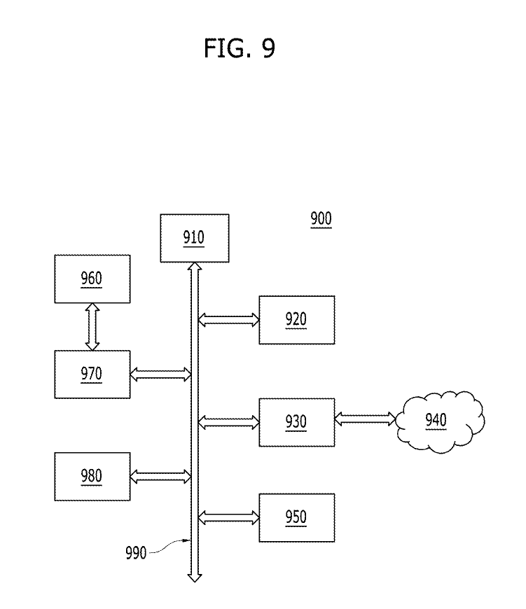

FIGS. 8A to 8C are block diagrams conceptually illustrating neuromorphic devices in accordance with embodiments.

Referring to FIG. 8A, the neuromorphic device in accordance with the embodiment may include a plurality of pre-synaptic neurons 10, a plurality of post-synaptic neurons 20, row lines R, and column lines C. The column lines C and the plurality of post-synaptic neurons 20 may be grouped into a plurality of bundles Ca, Cb, . . . , and Cx and 20a, 20b, . . . , and 20x, respectively. In this embodiment, the column line bundle Ca corresponds to the post-synaptic neuron bundle 20a, the column line bundle Cb corresponds to the post-synaptic neuron bundle 20b, and the column line bundle Cx corresponds to the post-synaptic neuron bundle 20x. Post-synaptic pulses may be delayed and generated on a bundle basis.

Referring to FIG. 8B, the neuromorphic device in accordance with the embodiment may include a plurality of pre-synaptic neurons 10, a plurality of post-synaptic neurons 20, row lines R, column lines C, and a timing controller 40A. The timing controller 40A may be coupled to column line bundles Ca, Cb, . . . , and Cx and post-synaptic neuron bundles 20a, 20b, . . . , and 20x on a bundle basis. Post-synaptic pulses may be delayed and generated on a bundle basis under the control of the timing controller 40A.

Referring to FIG. 8C, the neuromorphic device in accordance with the embodiment may include a plurality of pre-synaptic neurons 10, a plurality of post-synaptic neurons 20, row lines R, column lines C, and a timing controller 40B. The timing controller 40B may be connected to a corresponding post-synaptic neuron 20 in each of the bundles 20a, 20b, . . . , and 20x. Therefore, post-synaptic pulses may be delayed and generated on a basis of corresponding neurons within the bundles by the timing controller 40B. For example, an m-th post-synaptic neuron in each of the bundles may be grouped and connected to the same timing line. Therefore, the m-th post-synaptic neurons of the bundles can generate post-synaptic pulses at the same delayed time.

FIG. 9 is a block diagram conceptually illustrating a pattern recognition system 900 in accordance with an embodiment. For example, the pattern recognition system 900 may include one of a speech recognition system, an image recognition system, a code recognition system, a signal recognition system, and a system for recognizing various patterns.

Referring to FIG. 9, the pattern recognition system 900 in accordance with the embodiment may include a central processing unit (CPU) 910, a memory unit 920, a communication control unit 930, a network 940, an output unit 950, an input unit 960, an analog-digital converter (ADC) 970, a neuromorphic unit 980, and a bus 990. The CPU 910 may generate and transmit various signals for learning by the neuromorphic unit 980, and perform a variety of processes and functions for recognizing patterns such as voices and images according to an output of the neuromorphic unit 980.

The CPU 910 may be connected to the memory unit 920, the communication control unit 930, the output unit 950, the ADC 970, and the neuromorphic unit 980 through the bus 990.

The memory unit 920 may store various information with respect to operations of the pattern recognition system 900. The memory unit 920 may include one or more of a volatile memory device such as DRAM or SRAM, a nonvolatile memory device such as PRAM, MRAM, ReRAM, or NAND flash memory, and a memory unit such as a HDD (Hard Disk Drive) or a SSD (Solid State Drive).

The communication control unit 930 may transmit and/or receive data such as a recognized voice and image to and/or from a communication control unit of another system through the network 940.

The output unit 950 may output the data such as the recognized voice and image using various methods. For example, the output unit 950 may include one or more of various output devices including a speaker, a printer, a monitor, a display panel, a beam projector, a hologrammer, and so on.

The input unit 960 may include one or more of a microphone, a camera, a scanner, a touch pad, a keyboard, a mouse, a mouse pen, a sensor, and so on.

The ADC 970 may convert analog data transmitted from the input unit 960 into digital data.

The neuromorphic unit 980 may perform learning and recognition using the data transmitted from the ADC 970, and output data corresponding to a recognized pattern. The neuromorphic unit 980 may include one or more of the neuromorphic devices in accordance with the various embodiments.

In accordance with the embodiments, the learning methods for synapses of the neuromorphic device can increase the resistance dispersion of the trained and untrained synapses of the neuromorphic device as the number of learning periods is increased. Thus, the learning efficiency of the synapses of the neuromorphic device can be improved.

Although various embodiments have been described for illustrative purposes, it will be apparent to those skilled in the art that various changes and modifications may be made without departing from the spirit and scope of the invention as defined in the following claims.

What is claimed is:

1. A learning method for synapses of a neuromorphic device, the method comprising:
generating and inputting, by a pre-synaptic neuron, a first pre-synaptic pulse to a plurality of synapses at a first start time, the plurality of synapses being coupled to the pre-synaptic neuron;
generating and inputting, by a first post-synaptic neuron, a first post-synaptic pulse to a first synapse of the plurality of synapses at a first delayed time that is delayed by a first delay amount from the first start time, the first synapse being coupled to the first post-synaptic neuron; and
generating and inputting, by a second post-synaptic neuron, a second post-synaptic pulse to a second synapse of the plurality of synapses at a second delayed time that is delayed by a second delay amount from the first start time, the second synapse being coupled to the second post-synaptic neuron.

2. The learning method of claim 1, further comprising generating and inputting, by a third post-synaptic neuron, a third post-synaptic pulse to a third synapse of the plurality of synapses at a third delayed time, the third synapse being coupled to the third post-synaptic neuron.

3. The learning method of claim 2, further comprising generating and inputting, by a fourth post-synaptic neuron, a fourth post-synaptic pulse to a fourth synapse of the plurality of synapses at a fourth delayed time, the fourth synapse being coupled to the fourth post-synaptic neuron.

4. The learning method of claim 1, further comprising:
generating and inputting, by the pre-synaptic neuron, a second pre-synaptic pulse to the plurality of synapses at a second start time;
generating and inputting, by the second post-synaptic neuron, the first post-synaptic pulse to the second synapse at a first delayed time that is delayed by the first delay amount from the second start time; and
generating and inputting, the first post-synaptic neuron, the second post-synaptic pulse to the first synapse at a second delayed time that is delayed by the second delay amount from the second start time.

5. The learning method of claim 1,
wherein the first synapse is disposed at an intersection between a row line and a first column line, and the second synapse is disposed at an intersection between the row line and a second column line, the row line extending from the pre-synaptic neuron, the first and second column lines extending from the first and second post-synaptic neurons, respectively.

6. The learning method of claim 1, wherein the first and second delay amounts are adjusted by a timing controller electrically connected to the first and second post-synaptic neurons.

7. The learning method of claim 1, wherein the first pre-synaptic pulse overlaps the first post-synaptic pulse by a first duty time, and
wherein the first pre-synaptic pulse overlaps the second post-synaptic pulse by a second duty time.

8. The learning method of claim 7, wherein the first duty time is longer than the second duty time.

9. The learning method of claim 1, wherein the first pre-synaptic pulse has a first polarity, and
wherein the first and second post-synaptic pulses have a second polarity.

10. A learning method for synapses of a neuromorphic device, the method comprising:
generating and inputting, by a pre-synaptic neuron, a first pre-synaptic pulse to first to fourth synapses at a first start time, during a first cycle, the first to fourth synapses being electrically connected to the pre-synaptic neuron;
generating and inputting, by a first post-synaptic neuron, a first post-synaptic pulse to the first synapse at a first delayed time that is delayed from the first start time;
generating and inputting, by a second post-synaptic neuron, a second post-synaptic pulse to the second synapse at a second delayed time that is delayed from the first delayed time;
generating and inputting, by a third post-synaptic neuron, a third post-synaptic pulse to the third synapse at a third delayed time that is delayed from the second delayed time; and
generating and inputting, by a fourth post-synaptic neuron, a fourth post-synaptic pulse to the fourth synapse at a fourth delayed time that is delayed from the third delayed time.

11. The learning method of claim 10, further comprising:
generating and inputting, by the pre-synaptic neuron, a second pre-synaptic pulse to the first to fourth synapses at a second start time, during a second cycle;
generating and inputting, by the second post-synaptic neuron, a fifth post-synaptic pulse to the second synapse at a fifth delayed time that is delayed from the second start time;
generating and inputting, by the third post-synaptic neuron, a sixth post-synaptic pulse to the third synapse at a sixth delayed time that is delayed from the fifth delayed time;
generating and inputting, by the fourth post-synaptic neuron, a seventh post-synaptic pulse to the fourth synapse at a seventh delayed time that is delayed from the sixth delayed time; and
generating and inputting, by the first post-synaptic neuron, an eighth post-synaptic pulse to the first synapse at an eighth delayed time that is delayed from the seventh delayed time.

12. The learning method of claim 11, further comprising:
generating and inputting, by the pre-synaptic neuron, a third pre-synaptic pulse to the first and fourth synapses at a third start time during a third cycle;
generating and inputting, by the third post-synaptic neuron, a ninth post-synaptic pulse to the third synapse at a ninth delayed time that is delayed from the third start time;
generating and inputting, by the fourth post-synaptic neuron, a tenth post-synaptic pulse to the fourth synapse at a tenth delayed time that is delayed from the ninth delayed time;
generating and inputting, by the first post-synaptic neuron, an eleventh post-synaptic pulse to the first synapse at an eleventh delayed time that is delayed from the tenth delayed time; and
generating and inputting, by the second post-synaptic neuron, a twelfth post-synaptic pulse to the second synapse at a twelfth delayed time that is delayed from the eleventh delayed time.

13. The learning method of claim 12, further comprising:
generating and inputting, by the pre-synaptic neuron, a fourth pre-synaptic pulse to the first to fourth synapses at a fourth start time during a fourth cycle;
generating and inputting, by the fourth post-synaptic neuron, a thirteenth post-synaptic pulse to the fourth synapse at a thirteenth delayed time that is delayed from the fourth start time;
generating and inputting, by the first post-synaptic neuron, a fourteenth post-synaptic pulse to the first synapse at a fourteenth delayed time that is delayed from the thirteenth delayed time;
generating and inputting, by the second post-synaptic neuron, a fifteenth post-synaptic pulse to the second synapse at a fifteenth delayed time that is delayed from the fourteenth delayed time; and
generating and inputting, by the third post-synaptic neuron, a sixteenth post-synaptic pulse to the third synapse at a sixteenth delayed time that is delayed from the fifteenth delayed time.

14. The learning method of claim 10, wherein the first to fourth delayed times are adjusted by a timing controller which is electrically connected to the first to fourth post-synaptic neurons.

15. A learning method for synapses of a neuromorphic device, the method comprising:
generating and inputting, by a first pre-synaptic neuron, a first pre-synaptic pulse to a plurality of synapses at a start time, the plurality of synapses being electrically connected to the first pre-synaptic neuron;
generating and inputting, by a first post-synaptic neuron bundle having a plurality of first post-synaptic neurons, a plurality of first post-synaptic pulses to first synapses among the plurality of synapses at a first delayed time, the first synapses being electrically connected to the first post-synaptic neuron bundle; and
generating and inputting, by a second post-synaptic neuron bundle having a plurality of second post-synaptic neurons, a plurality of second post-synaptic pulses to second synapses among the plurality of synapses at a second delayed time, the second synapses being electrically connected to the second post-synaptic neuron bundle.

16. The learning method of claim 15, further comprising generating and inputting, by a third post-synaptic neuron bundle having a plurality of third post-synaptic neurons, a plurality of third post-synaptic pulses to third synapses among the plurality of synapses at a third delayed time, the third synapses being electrically connected to the third post-synaptic neuron bundle.

17. The learning method of claim 16, further comprising generating and inputting, by a fourth post-synaptic neuron bundle having a plurality of fourth post-synaptic neurons, a plurality of fourth post-synaptic pulses to fourth synapses among the plurality of synapses at a fourth delayed time, the fourth synapses being electrically connected to the fourth post-synaptic neuron bundle.

18. The learning method of claim 17, wherein the first delayed time is delayed by a first delay amount from the start time, wherein the second delayed time is delayed by a second delay amount from the first delayed time,
wherein the third delayed time is delayed by a third delay amount from the second delayed time, and
wherein the fourth delayed time is delayed by a fourth delay amount from the third delayed time.

19. The learning method of claim 18, wherein the first to fourth delay amounts have the same length.
